(19) United States
(12) Patent Application Publication
(10) Pub. No.: US 2023/0256657 A1
(43) Pub. Date: Aug. 17, 2023

(54) Device and Method for Laminating a Substrate with a Thermoplastic Film

(71) Applicant: Henkel AG & Co. KGaA, Duesseldorf (DE)

(72) Inventors: Kai Ethner, Langenfeld (DE); Hans-Georg Kinzelmann, Pulheim (DE)

(21) Appl. No.: 18/194,815

(22) Filed: Apr. 3, 2023

Related U.S. Application Data
(63) Continuation of application No. PCT/EP2021/075763, filed on Sep. 20, 2021.

(30) Foreign Application Priority Data
Oct. 9, 2020 (EP) 20200945.2

(51) Int. Cl. B29C 43/02; B29C 43/34; B29C 43/52

(52) U.S. Cl. CPC B29C 43/02; B29C 43/34; B29C 43/52; B29C 2043/3422; B29C 2043/345; B29C 2043/522; B29C 2043/527; B29K 2101/12

(57) ABSTRACT

The invention relates to an apparatus (1) for laminating a substrate (12) with a thermoplastic film (11), the apparatus (1) comprising the following: —a laminating unit (2) for laminating the substrate (12) with the thermoplastic film (11), —a feed device (4) for the thermoplastic film (11) to the laminating unit (2), wherein the feed device (4) for the thermoplastic film (11) has devices (14) for heating a first side (16) of the film (11) and devices (15) for cooling a second side (17) of the film (11), as well as a number of controllably driven rollers (10) via which the film (11) is guided past the devices (14) for heating and the devices (15) for cooling, wherein a tension of the film (11) can be regulated via the speed of the driven rollers (10).

The present invention relates to a method and an apparatus for continuously laminating a substrate with a thermoplastic coating material, in particular a film. The substrate can also be a film. However, it can also be a solid body made of plastics material, metal or another material.

Various methods for laminating substrates with a thermoplastic film are known. EP 3 183 117 B1 describes a method and an apparatus for bonding two film-like substrates, at least one film being guided on a conveyor belt past a cooling and heating device in such a way that one side of the film is cooled but the other is heated.

EP 3 526 042 B1 discloses a similar method in which, in contrast, one film is guided on a cooled roller and is subsequently connected to the second film also on this roller.

As has been found, however, due to gravity-related or thermally induced changes in length of the thermoplastic film, difficulties can arise when the thermoplastic film is fed and during subsequent lamination, in particular leading to a fold or a tearing of the film.

It is therefore an object of the present invention to specify an apparatus and a method for laminating a substrate with a thermoplastic film which do not have the disadvantages mentioned.

This object is achieved by the subject matter of the independent claims. Advantageous embodiments and developments are the subject matter of the dependent claims.

According to one aspect of the invention, an apparatus for laminating a substrate with a thermoplastic film is specified, the apparatus having a laminating unit for laminating the substrate with the thermoplastic film, and a feed device for the thermoplastic film to the laminating unit. The feed device for the thermoplastic film has devices for heating a first side of the film and devices for cooling a second side of the film, as well as a number of controllably driven rollers via which the film is guided past the devices for heating and the devices for cooling, and a tension of the film can be regulated via the speed of the driven rollers.

A laminating unit is understood here and below to mean an apparatus that performs the coating, in particular by means of pressure, of the substrate with the thermoplastic film. For this purpose, rollers are typically provided by which the two films are guided if the substrate is designed as a film. If the substrate is not designed as a film, the laminating unit often also comprises at least one roller by means of which the thermoplastic film is applied to the substrate.

The apparatus has the advantage that it allows the thermoplastic film to be guided in a practically contactless manner by means of the controllably driven rollers. Accordingly, in the feed device, the film does not lie, at least in portions, flat on a conveyor belt or a roller with a large diameter or another surface but is only supported and conveyed at specific points by the controllably driven rollers and is optionally deflected and otherwise guided in a contactless manner. Since the rotational speed of the driven rollers can be controlled, in particular even regulated, tensions within the film can be equalized by building up speed differences between individual rollers. If, for example, the guided film loses tension, a speed difference between two rollers can be set in such a way that the film is tensioned again. This is particularly advantageous because heating the thermoplastic film causes both expansion and softening of the film.

The apparatus for laminating the substrate with a thermoplastic film can also have a feed device for the substrate, the design of which depends on the type of substrate. In particular, infrared emitters can be provided as devices for heating the film, although other heat sources such as lasers may also be provided. For cooling, cooled metal sheets may be provided, for example.

According to one embodiment, driven rollers are arranged, in the direction of movement of the film, at least upstream of and downstream of the devices for cooling and heating. This embodiment has the advantage that changes in the length of the thermoplastic film caused by heating or cooling the film can be compensated for by regulating the speed of the rollers.

The thermoplastic film is guided in particular at a distance from the devices for heating. The thermoplastic film therefore does not come into contact with elements of the devices for heating.

The devices for cooling can comprise at least one cooled roller over which the film is guided. In this embodiment, a controllably driven roller can be provided in particular upstream of the cooled roller, by means of which roller a tension of the film can be controlled or regulated via the speed differential to the cooled roller.

Alternatively, the thermoplastic film can be guided at a distance from the devices for cooling. In the latter case, the devices for cooling are arranged along the film web tensioned between the rollers in the feed device, although not on the same side of the film as the devices for heating, but on the opposite side.

According to one embodiment, grids are arranged between the devices for heating and the thermoplastic film for protecting the devices for heating from any contact with the film. Such grids have the advantage that they prevent contact between the thermoplastic film and the devices for heating. As an additional safety mechanism, the feed device can have at least one device for generating an air flow between the thermoplastic film and the devices for heating.

The device for generating an air flow can be designed as a blower, a compressed air source or as a vacuum source. It has the advantage that if the web tension of the film is too low or if the web tears, the film is prevented from sticking to the grid or to the heating apparatus. For this purpose, the device for generating an air flow can be automatically and/or manually switched on when the web tension is lost. In this case, said device can blow cold air between the device for heating and the film or the grid, for example. If a grid is provided, the air escapes through the grid and blows the film away from the devices for heating.

There are various options for the arrangement of the driven rollers and optionally further rollers or deflecting rollers of the feed device. For example, the thermoplastic film can be guided in the feed device vertically upward and/or downward at least in portions. However, it can also be guided obliquely upward and/or downward at least in portions. In addition, the thermoplastic film can be guided on a circular arc at least in portions. Which arrangement is chosen can depend, among other things, on the space available and other practical considerations.

According to one embodiment, the feed device has an alternative feed path for the film that does not comprise any devices for heating or any devices for cooling. On this alternative feed path, the film is thus fed to the laminating unit without being heated. The alternative feed path can be used, for example, if a thermoplastic film is not used for lamination but another material, or if the connection between the film and the substrate is established in a different way, for example by means of a separately applied adhesive. In particular, if different methods are to be used simultaneously or alternately in one system, the presence of the alternative feed path is advantageous.

According to one embodiment, the apparatus has a device for collecting condensate produced on the devices for cooling. This device can be designed, for example, as a trough and can be placed in such a way that it collects, from the devices for cooling, condensate formed and dripping due to the moist ambient air. As has namely been found, considerable amounts of condensate can form during operation on the devices for cooling, which amounts are not intended to get into the system in an uncontrolled manner because they can damage the surfaces of the thermoplastic film, among other things.

According to a further aspect of the invention, a method for laminating a substrate with a thermoplastic film is specified, the method comprising feeding the film to a laminating unit, the feeding taking place by means of a number of controllably driven rollers via which the film is guided, the film, during feeding, being heated on a first side and cooled on a second side, a tension of the film, during feeding, being controlled and in particular also regulated via the speed of the driven rollers.

In particular, the speed in the feed device can be regulated in portions, which is made possible by the fact that the driven rollers can be regulated individually. If the rollers can be regulated in terms of speed independently of one another, it is possible to set differential speeds between successive rollers, by means of which tension in the film can be built up or relieved.

In the method, the film can be guided in a contactless manner at least in portions and can be supported only at specific points by the controllably driven or simple rollers. This also has the advantage that lower frictional forces occur on the film than in the case of a guide on a conveyor belt or via a roller.

The substrate, which can be present in the form of a film or in another form, is also fed to the laminating unit.

According to one embodiment, the film is held at a distance from the devices for heating by an air flow blown into a space between the film and the devices for heating. For this purpose, it can be provided in particular that air blown into the space exits through openings in a grid and blows the film away from the devices for heating.

According to one embodiment, a condensate which forms on the devices for cooling is absorbed and, if necessary, removed.

Embodiments of the invention are explained in more detail below with reference to schematic figures.

### BRIEF DESCRIPTION OF THE DRAWINGS

FIG. 1 schematically shows an apparatus for laminating a substrate with a thermoplastic film according to a first embodiment of the invention;

FIG. 2 schematically shows an apparatus for laminating a substrate with a thermoplastic film according to a second embodiment of the invention;

FIG. 3 schematically shows an apparatus for laminating a substrate with a thermoplastic film according to a third embodiment of the invention; and

FIG. 4 schematically shows an apparatus for laminating a substrate with a thermoplastic film according to a fourth embodiment of the invention.

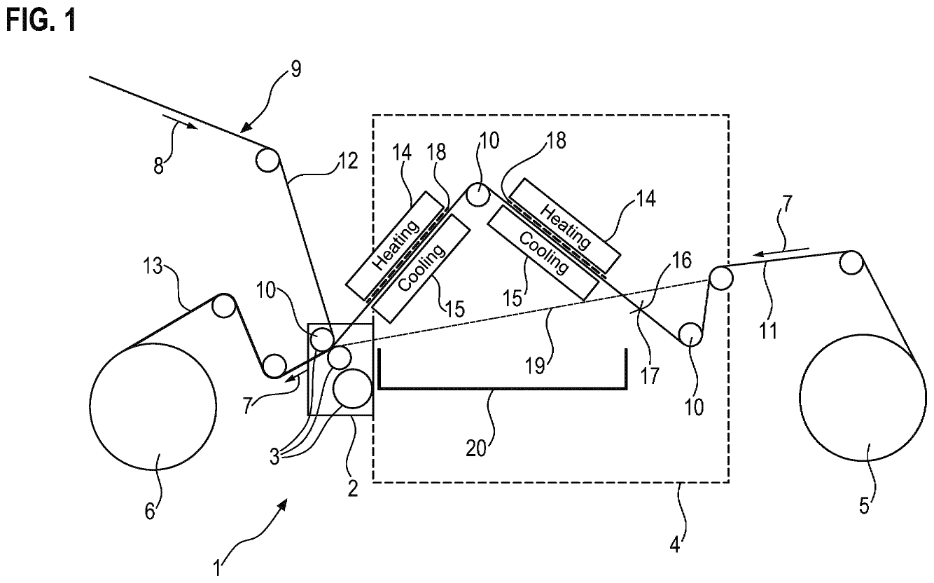

FIG. 1 shows an apparatus 1 for laminating a substrate with a thermoplastic film. In FIG. 1, the thermoplastic film is denoted by the reference sign 11, the substrate by the reference sign 12 and the already laminated substrate by the reference sign 13.

The apparatus 1 comprises a laminating unit 2, which in particular has a number of rollers 3 for pressing the film 11 onto the substrate 12. Furthermore, the apparatus 1 comprises a feed device 4 for the thermoplastic film 11 to the laminating unit 2. The film 11 is unwound by an unwinder 5 and transported by means of the feed device 4 to the laminating unit 2, after which the coated substrate 13 is wound by the rewinder 6.

The feed device 4 has a number of controllably driven rollers 10. In the embodiment shown, three driven rollers 10 are illustrated. However, this illustration is only exemplary and more or fewer driven rollers can also be provided.

The feed device 4 comprises further rollers or rolls which serve to guide and deflect the film 11 and are only shown by way of example and are not described in more detail. The thermoplastic film 11 is transported by means of the driven rollers 10 in the direction of the arrow 7 (feed direction) to the laminating unit 2. In the embodiment shown, the substrate 12 is transported along the arrow 8 (feed direction) to the laminating unit 2 also by means of a suitable feed device 9. After lamination, the laminated substrate 13 is transported along the arrow 7 to the rewinder 6.

The film 11 is fed largely contactlessly. Only in the region of the rollers 10 is the film 11 guided or supported at specific points. The film 11 is not supported between the rollers 10. It thus has a tension caused in particular by the gravity acting thereon and by the rotational speeds of the rollers 10.

Along its path through the feed device 4, the thermoplastic film 11 is guided between the rollers 10 past devices 14 for heating a first side 16 of the film 11 and devices 15 for cooling a second side 17 of the film 11. The devices 14 for heating and the devices 15 for cooling are also shown here merely by way of example. The number and arrangement of the devices 14 for heating and the devices 15 for cooling can vary.

Heating the first side 16 causes softening to partial melting of the thermoplastic film 11 on its first side 16, such that said film can bond to the substrate in the laminating unit 2. Cooling the second side 17 serves to prevent the film 11 from melting completely and to maintain a certain stability, which is necessary for the transport process to the laminating unit 2.

The film 11 is guided away from the devices 14 for heating and the devices 15 for cooling. Grids 18 are arranged between the devices for heating 14 and the film 11, which are intended to prevent the film 11 from adhering to the devices 14 for heating.

The feed device 4 has an alternative feed path for a film to the laminating unit 2, which is indicated in FIG. 1 by a dashed line 19 and which is not guided past the devices 14 for heating and devices 15 for cooling. The alternative path can be used for a film which does not consist of a thermoplastic material or which is not to be heated or cooled for other reasons.

The apparatus 1 further comprises a trough 20 for collecting condensate which is formed on the devices 15 for cooling due to the moist ambient air. The trough 20 is arranged below the devices 15 for cooling, such that condensate flows off the devices 15 for cooling due to gravity and drips into the trough 20. On this path, the condensate does not pass through any further elements of the feed device 4, in particular not the devices 14 for heating, which could be damaged by the condensate. The trough 20 is thus positioned in such a way that condensate forming on the devices 15 can drip directly into the trough 20. Discharging the condensate ensures that no condensate comes into contact with the film 11, which could reduce the quality of the surface.

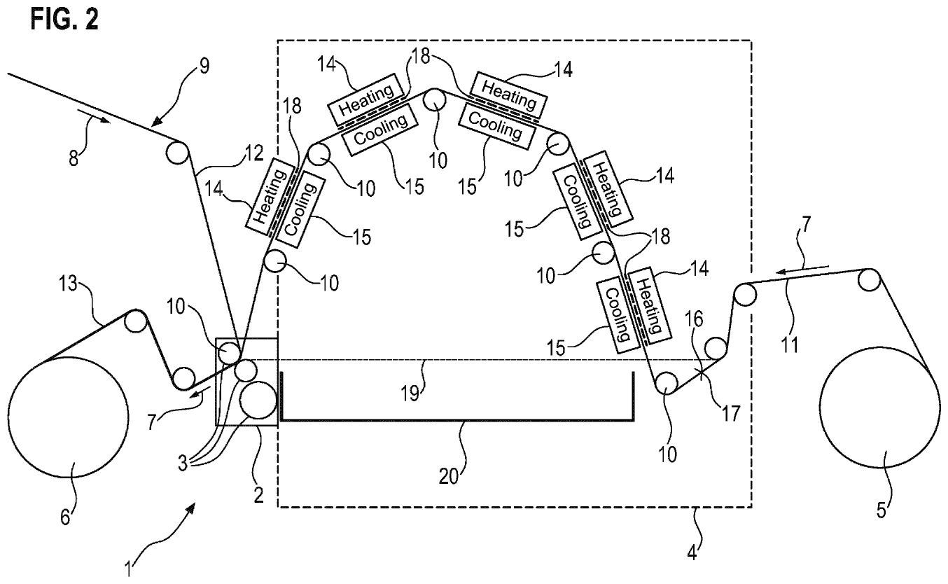

FIG. 2 shows a second embodiment of an apparatus 1 for laminating a substrate with a thermoplastic film. This apparatus 1 differs from the embodiment shown in FIG. 1 in that several driven rollers 10 are provided which guide the film 11 on a semi-circular path.

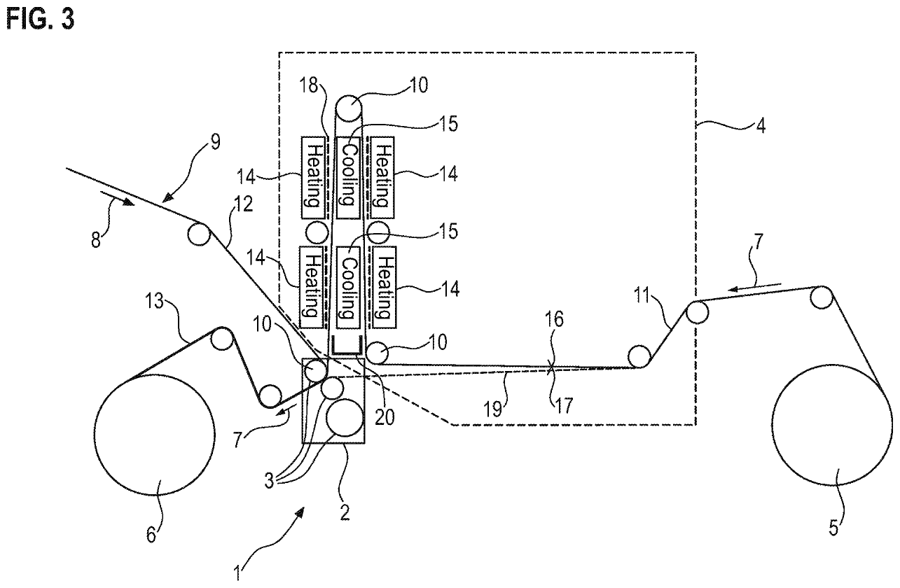

FIG. 3 shows a third embodiment of the apparatus 1 for laminating a substrate with a thermoplastic film 11. This embodiment differs from those previously shown in that several driven rollers 10 are arranged one above the other such that the film 11 is guided vertically in portions. In the embodiment shown, two devices 14 for heating and two devices 15 for cooling are also arranged one above the other in each case.

This arrangement is particularly space-saving and can also be implemented in a small installation space. The devices 15 for cooling are arranged one above the other in this embodiment, but not above devices 14 for heating, so that no condensate can drip onto the devices 14 for heating. A trough 20 for collecting condensate is again provided immediately below the lower device 15 for cooling.

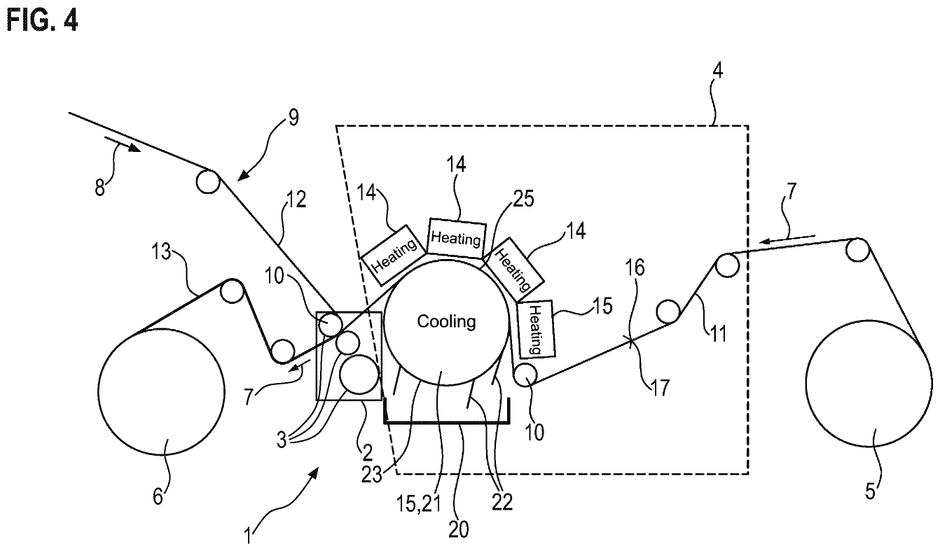

FIG. 4 shows a fourth embodiment of the apparatus 1 for laminating a substrate 12 with a thermoplastic film 11. This embodiment differs from those previously shown in that the film 11 is guided in portions in the feed device 4 not in a contactless manner, but by means of a cooled roller 21. The second side 17 of the film 11 thus rests, in places, on the surface of the cooled roller 21. The speed of the cooled roller 21 can also be controllably driven.

However, the film is guided in a contactless manner on the route portion between the first driven roller 10 and the cooled roller 21. The roller 10 has the task of compensating for stresses arising from the heating in the film 11.

In this embodiment, scrapers 22 are provided which scrape condensate produced on the cooled roller 21 from the roller 21 and let it drip into the trough 20. In this case, the scrapers 22 are arranged in the region of a lower side 23 of the roller 21, while the film 11 is guided on the upper side 24 of the roller 21. In this way, the film 11 is prevented from coming into contact with condensate on the surface of the roller 21, which could reduce the quality of the film surface.

### LIST OF REFERENCE SIGNS

1 Apparatus
2 Laminating unit
3 Roller
4 Feed device
5 Unwinder
6 Rewinder
7 Arrow
8 Arrow
9 Feed device
10 Roller
11 Film
12 Substrate
13 Laminated substrate
14 Device for heating
15 Device for cooling
16 First side
17 Second side
18 Grid
19 Dashed line
20 Trough
21 Roller
22 Scraper
23 Lower side
24 Upper side

1. An apparatus for laminating a substrate to a thermoplastic film, comprising:
a laminating unit for laminating the substrate with the thermoplastic film;
a feed device for the thermoplastic film to the laminating unit, the feed device for the thermoplastic film including,
one or more devices for heating a first side of the film,
one or more devices for cooling a second side of the film,
a plurality of controllably driven rollers via which the film is guided past the devices for heating and the devices for cooling;
wherein a tension of the film can be regulated via the speed of the driven rollers.

2. The apparatus according to claim 1,
wherein the driven rollers are arranged, in the direction of movement of the film, at least upstream of and downstream of the devices for heating and for cooling.

3. The apparatus according to claim 1, wherein the thermoplastic film is guided at a distance from the devices for heating.

4. The apparatus according to claim 1, wherein the devices for cooling comprise at least one cooled roller over which the film is guided.

5. The apparatus according to claim 1, wherein the thermoplastic film is guided at a distance from the devices for cooling.

6. The apparatus according to claim 1, wherein, grids are disposed between the devices for heating and the thermoplastic film, the grids being arranged for protecting the devices for heating from contact with the film.

7. The apparatus according to claim 1, wherein the feed device has at least one device for generating an air flow between the thermoplastic film and the devices for heating.

8. The apparatus according to claim 1, wherein the thermoplastic film is guided in the feed device vertically upward and/or downward at least in portions.

9. The apparatus according to claim 1, wherein the thermoplastic film is guided in the feed device obliquely upward and/or downward at least in portions.

10. The apparatus according to claim 1, wherein the thermoplastic film is guided in the feed device around a circular arc at least in portions.

11. The apparatus according to claim 1, wherein the feed device has an alternative feed path for a film which does not comprise any devices for heating or any devices for cooling.

12. The apparatus according to claim 1, further comprising a device for collecting condensate formed at the devices for cooling.

13. A method for laminating a substrate to a thermoplastic film, comprising:
providing the substrate;
providing the thermoplastic film;
providing a laminating unit;
feeding the film to the laminating unit, wherein the feeding takes place by means of a plurality of controllably driven rollers via which the film is guided,
wherein during feeding the film is heated on a first side and cooled on a second side, and during feeding a tension of the film is regulated via the speed of the driven rollers.

14. The method according to claim 13, comprising one or more devices for heating and one or more devices for blowing air, wherein the film is held at a distance from the devices for heating by an air blown into a space between the film and the devices for heating.

15. The method according to claim 13, comprising the step of collecting a condensate which forms at devices for cooling.
